(19) United States
(12) Patent Application Publication
(10) Pub. No.: US 2026/0196190 A1
(43) Pub. Date: Jul. 9, 2026

(54) GUITAR BODY STRUCTURE AND GUITAR

(71) Applicant: Yamaha Corporation, Hamamatsu (JP)

(72) Inventors: Hideto MATSUDA, Hamamatsu (JP); Kazuki KASHIWASE, Tokyo (JP)

(21) Appl. No.: 19/551,169

(22) Filed: Feb. 26, 2026

Related U.S. Application Data
(63) Continuation of application No. PCT/JP2024/029488, filed on Aug. 20, 2024.

(30) Foreign Application Priority Data
Sep. 5, 2023 (JP) 2023-143715

(51) Int. Cl. G10D 1/08; G10D 3/22

(52) U.S. Cl. CPC G10D 1/085; G10D 3/22

(57) ABSTRACT

A body structure of a guitar includes a body including a wooden portion made of rosewood. As viewed from a thickness direction of the body, a grain direction of the wooden portion is inclined relative to a longitudinal direction of a neck of the guitar.

### CROSS-REFERENCE TO RELATED APPLICATIONS

This application is a continuation application of PCT International Application No. PCT/JP2024/029488 filed on August 20, 2024, which claims priority to Japanese Patent Application No. 2023-143715 filed in Japan on September 5, 2023. The entire disclosures of International Application No. PCT/JP2024/029488 and Japanese Patent Application No. 2023-143715 are hereby incorporated herein by reference.

### BACKGROUND

### Field of the Invention

This disclosure generally relates to a guitar body structure and a guitar.

### Background Information

A technique is known from the prior art in which, in a body structure of a guitar provided with a body that includes a wooden portion, attention is paid to the grain direction of the wooden portion. For example, in Japanese Patent No. 4373854, the grain direction of the top and back plates is oriented in the longitudinal direction of the resonance body.

### SUMMARY

In the field of guitars, including electric guitars, wood suitable for use in the body is limited to some extent from the viewpoint of tonal quality. If, in the future, it is possible to use wood that has not been traditionally used in guitars, it would lead to effective use of wood, which is also useful from the viewpoint of sustainability.

If wood used for the body has a higher elastic modulus than wood that is commonly used for guitar bodies, the peak frequency increases and the tonal quality will change compared to when using wood that does not have a high elastic modulus. If wood having a high elastic modulus is used in the body in a case in which the grain direction is aligned in the longitudinal direction of the neck as in Japanese Patent No. 4373854, body rigidity becomes high so that it may not be possible to obtain the desired tonal quality.

One object of this disclosure is to provide a guitar body structure (a body structure of a guitar) with which it is possible to obtain the desired tonal quality even when using rosewood for the body.

One embodiment of this disclosure provides a body structure of a guitar includes a body including a wooden portion made of rosewood. A grain direction of the wooden portion is inclined with respect to a longitudinal direction of a neck of the guitar as viewed from the thickness direction of the body.

### BRIEF DESCRIPTION OF THE DRAWINGS

FIG. 1 is a front view of a guitar to which a body structure according to a first embodiment is applied.

FIG. 2 is a front view of the body as viewed from the +Z side.

FIG. 3 is a diagram showing an acceleration response relative to frequency.

FIG. 4 is a diagram showing the relationship between acute angle and body rigidity in the longitudinal direction of the neck.

FIG. 5 is a front view of the body in a second embodiment as viewed from the +Z side.

FIG. 6 is a front view of the body in a third embodiment as viewed from the +Z side.

FIG. 7 is a schematic cross-sectional view of a wooden portion of a first modified example.

FIG. 8 is a front view of the body of a second modified example as viewed from the +Z side.

### DETAILED DESCRIPTION OF EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

An embodiment of this disclosure will be described below with reference to the drawings.

### First Embodiment

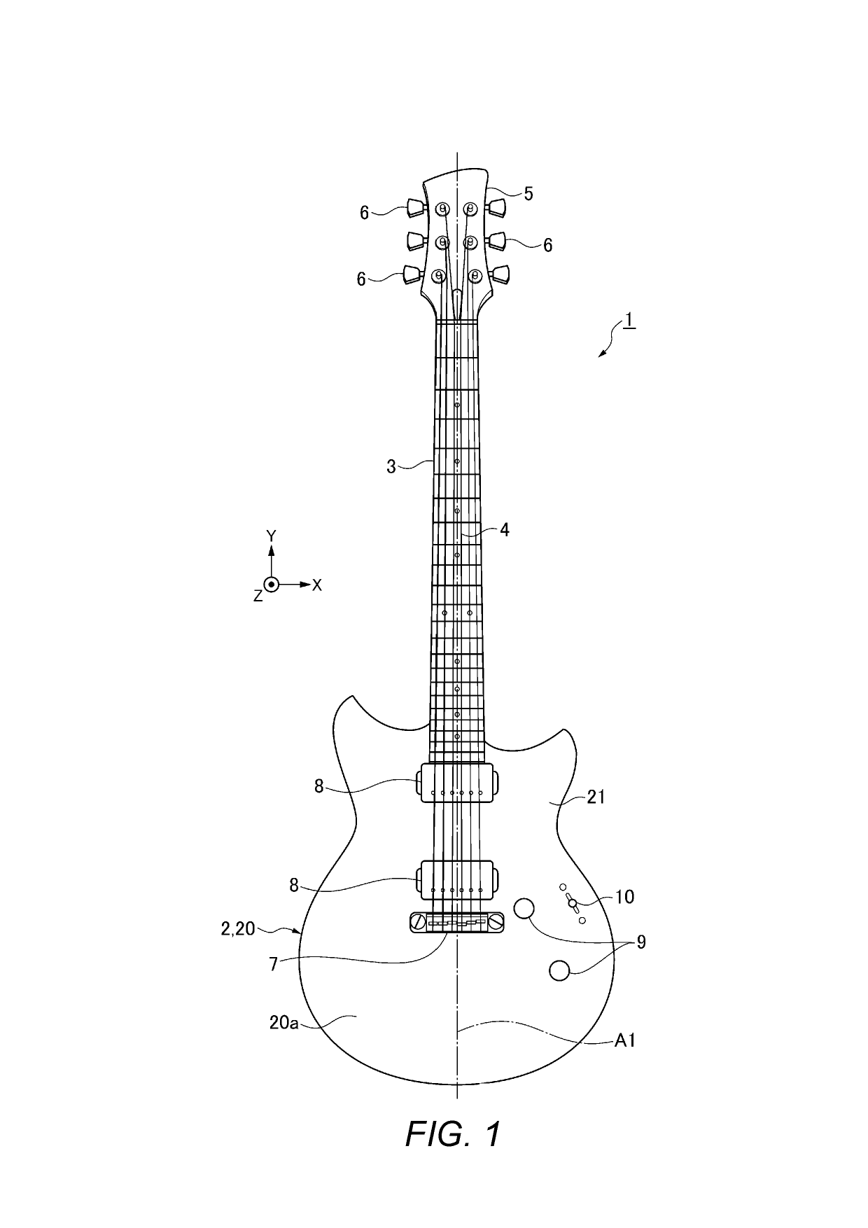

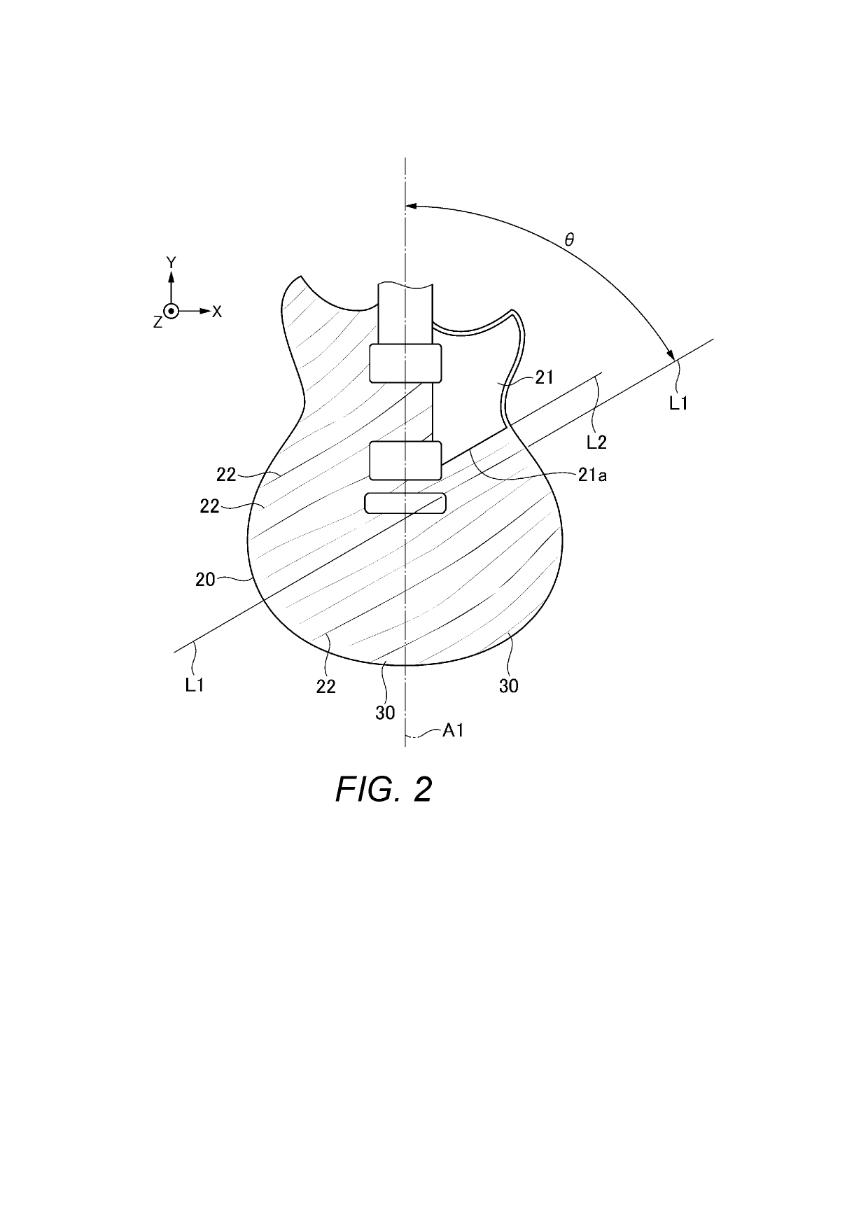

FIG. 1 is a front view of a guitar to which a body structure according to the first embodiment of this disclosure is applied. For example, the guitar 1 is an electric guitar. The guitar 1 includes a body structure 2, a neck 3, and strings 4. The body structure 2 includes a body 20 including a wooden portion 30 (refer to FIG. 2) made of wood. In the present embodiment, the body 20 constitutes the entire body structure 2. The body 20 is formed in a plate shape.

In the following description, of the directions orthogonal to the thickness direction (Z direction) of the body 20, the longitudinal direction of the neck 3 is defined as the longitudinal direction (Y direction) of the body 20. The direction orthogonal to the longitudinal direction and the thickness direction of the body 20 is defined as the width direction (X direction) of the body 20.

The neck 3 is connected to an end of the body structure 2 and extends in a direction (+Y direction) away from the body structure 2. A head 5 forming the distal end portion of the neck 3 in the longitudinal direction is provided with pegs 6 around which the ends of the strings 4 are wound. The strings 4 are strung along the longitudinal direction of the neck 3.

A bridge 7, electromagnetic pickups 8, a controller, and the like, are attached to the body 20. The bridge 7, the electromagnetic pickups 8, and the controller are exposed on a front surface 20a, which is the +Z side surface in the thickness direction of the body 20.

One end of each of the strings 4 is fastened to the bridge 7. The electromagnetic pickups 8 are located between the neck 3 and the bridge 7 in the longitudinal direction of the neck 3. A plurality of the electromagnetic pickups 8 (two in the illustrated example) are arranged in the longitudinal direction of the neck 3. The controller adjusts the volume, tone, etc., of the audio signal output from the electromagnetic pickups 8. The controller includes two volume switches 9, a pickup selector 10 for switching between which of the electromagnetic pickups 8 to enable, and the like.

In the present embodiment, the wooden portion 30 included in the body 20 is made of rosewood (Fabaceae, Dalbergia genus). Rosewood is wood having a higher elastic modulus compared to wood (for example, hard maple, having an elastic modulus of about 10 to 14 GPa) widely used in bodies of electric guitars. If the elastic modulus is high, the rigidity of the body 20 increases and the peak frequency becomes high, and, as a result, it cannot be possible to obtain the desired tonal quality.

Therefore, in the present embodiment, rosewood, which is wood that has a relatively high elastic modulus, is used for the wooden portion 30, while ingenuity is applied to the grain direction of the wooden portion to reduce the rigidity of the body 20. Rosewood that can be used for the wooden portion 30 can be one of Indian rosewood, Madagascar rosewood, Honduran rosewood, jacaranda (Brazilian rosewood, commonly known as jacaranda), sonokeling, or Guatemalan rosewood, or a combination of two or more of the above (i.e., Indian rosewood, Madagascar rosewood, Honduran rosewood, jacaranda (Brazilian rosewood, commonly known as jacaranda), sonokeling, or Guatemalan rosewood). In addition, in the present embodiment, the wooden portion 30 included in the body 20 can be formed by a plurality of wood pieces being laminated in the Z direction, or can be formed from a single wooden piece.

FIG. 2 is a front view of the body 20 as viewed from the +Z side. The center line A1 is an imaginary straight line that passes through the center of the body 20 in the width direction (X1 direction) and extends in the longitudinal direction of the neck 3 (Y direction).

A plurality of wood grains 22 are present in the wooden portion 30 of the body 20. The directions in which the plurality of wood grains 22 extend as viewed from the Z direction (hereinbelow, used synonymously with the thickness direction of the body 20) are generally parallel to each other. The direction in which the wood grains 22 extend as viewed from the Z direction is referred to as the grain direction. The grain direction is a concept in which the directions in which the plurality of wood grains 22 extend are averaged. An imaginary straight line parallel to the grain direction as viewed from the Z direction is defined as a straight line L1. The grain direction can be defined as the same direction as the orientation of fibers of the wood constituting the wooden portion 30.

A pickguard 21 is provided on the body 20. The pickguard 21 is disposed on the +Z side of the wooden portion 30. An imaginary straight line parallel to the direction in which one side 21a of the pickguard 21 extends as viewed from the Z direction is defined as a straight line L2.

As shown in FIG. 2, the grain direction of the wooden portion 30 is inclined with respect to the longitudinal direction of the neck 3 as viewed from the Z direction. That is, as viewed from the Z direction, the straight line L1 is not parallel to the center line A1, which is parallel to the longitudinal direction of the neck 3. The straight line L1 and the straight line L2 are parallel to each other.

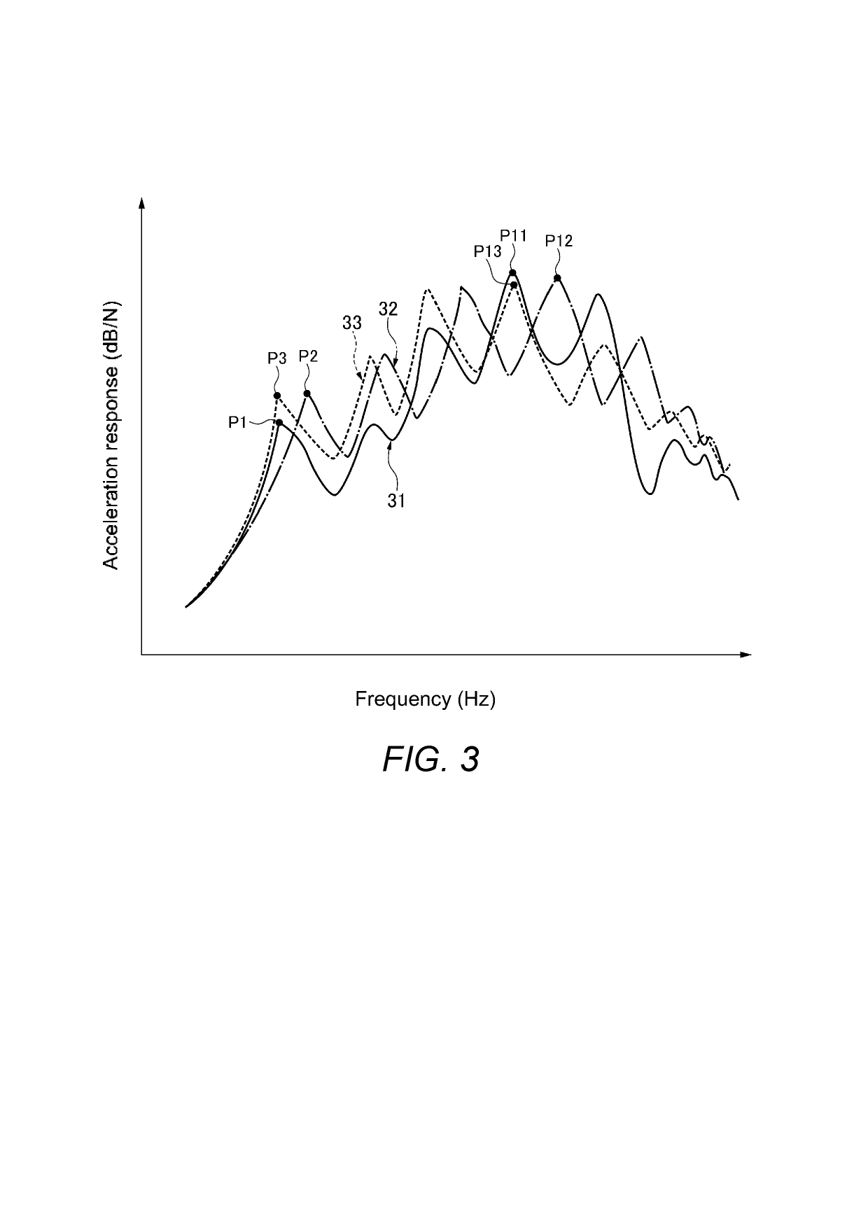

As viewed from the Z direction, the acute angle formed by the center line A1 and the grain direction is defined as an acute angle θ. In the example shown in FIG. 2, the acute angle θ formed by the center line A1 and the grain direction on the neck 3 side (+Y side) in the longitudinal direction of the neck 3 is set to 60˚. In addition, the acute angle formed by the center line A1 and the grain direction on the side opposite to the neck 3 (-Y side) in the longitudinal direction of the neck 3 is the same as the acute angle θ. The effect of tilting the grain direction relative to the center line A1 will be described with reference to FIG. 3.

FIG. 3 is a diagram showing acceleration response (dB/N) relative to frequency (Hz). Acceleration response corresponds to the level of vibration. FIG. 3 shows three combinations of grain directions and wood materials used for the wooden portion 30.

The method of acquiring the acceleration response is as follows. A worker vibrates the head 5, detects the vibration at a plurality of locations near the outer peripheral portion of the body 20, and averages the detected values. The worker executes this operation a plurality of times while changing the value of the vibration of the head 5, for each combination of a wood material and grain direction. As a result of this operation, the acceleration response corresponding to the frequency is obtained for each combination (first to third examples) of wood material and grain direction.

The first example is an example in which wood (for example, maple or mahogany) used in many guitars is used, and the grain direction is set to be parallel to the center line A1 (acute angle θ =0˚); curve 31 corresponds to this example.

The second example is an example in which Honduran rosewood among rosewood is used, and the grain direction is set to be parallel to the center line A1 (acute angle θ = 0˚); curve 32 corresponds to this example.

The third example is an example in which Honduran rosewood is used, and the grain direction is inclined by 60˚ with respect to the center line A1 (acute angle θ = 60˚); curve 33 corresponds to this example.

Of the peaks of the acceleration response, peaks P1 to P3 and P11 to P13 will be described as examples. Peaks P1, P2, and P3 are the peaks of the first, second, and third examples, respectively. Peaks P11, P12, and P13 are also the peaks of the first, second, and third examples, respectively.

Compared to the frequencies at which the peaks P1 and P11 of the first example occur, the frequencies at which the peaks P2 and P12 of the second example occur are higher. That is, compared to the first example, the peak frequencies are shifted to the higher side in the second example. This is because the elastic modulus of the wood that is used increased, thereby increasing the rigidity of the body 20.

The frequencies at which the peaks P3 and P13 of the third example occur are lower than the frequencies at which the peaks P2 and P12 of the second example occur, and are closer to the frequencies at which the peaks P1 and P11 of the first example occur. This is because the effect of increased rigidity, caused by the increase in the elastic modulus of the wood that is used, is offset by tilting the grain direction by 60˚ with respect to the center line A1. That is, the rigidity of the body 20 is reduced by the inclination of the grain direction. As a result, in the third example, the rigidity of the body 20 is about the same as that in the first example, so that it is possible to achieve the desired tonal quality while using wood having a high elastic modulus.

Here, the rigidity of the body 20 that contributes to the tonal quality is mainly the bending rigidity of the body 20 in the longitudinal direction of the neck 3, corresponding to the rigidity against bending about the X-axis. However, the rigidity to be changed by tilting the grain direction can include tensile rigidity and compressive rigidity, and bending rigidity in other directions.

From the viewpoint of reducing the rigidity of the body 20 by tilting the grain direction, the acute angle θ is not limited to 60˚, and can be any angle greater than 0˚, but preferably greater than or equal to 30˚ and less than or equal to 70˚.

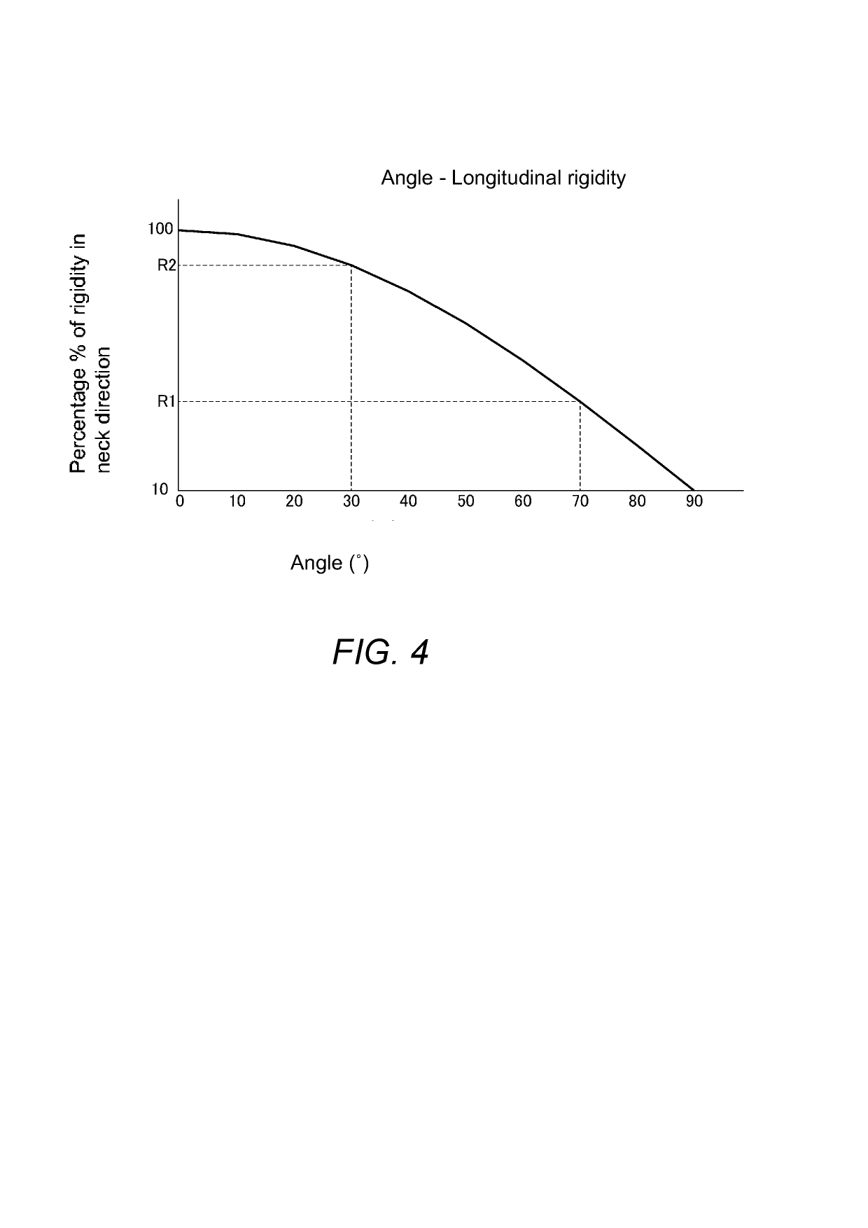

FIG. 4 is a diagram showing the relationship between the acute angle θ and the rigidity of the body 20 in the longitudinal direction of the neck 3. In this diagram, the percentage of decrease in the rigidity when the acute angle θ is changed from 0˚ to 90˚ is shown, with a case in which the grain direction is set to be parallel to the center line A1 (acute angle θ = 0˚) serving as the reference (100%).

As a characteristic of typical wood, compared to the grain direction (fiber direction, straight line L1 direction), the elastic modulus of the orthogonal direction (radial direction) thereof decreases to about 1/10. As a result, for example, the rigidity when the acute angle θ is 90˚ is 10%, which is a reduction to about 1/10 compared to when the acute angle θ is 0˚. When the acute angle θ is greater than or equal to 30˚ and less than or equal to 70˚, the rigidity falls within the range of R2 to R1 (R1 < R2). R2 to R1 is a range suitable as the rigidity of the body 20 after reduction, and is approximately 92 to 43%.

In addition, from the viewpoint of achieving the effect of this disclosure, in terms of the elastic modulus of rosewood that can be used for the wooden portion 30, it is sufficient if the elastic modulus of the rosewood is greater than or equal to 17 GPa, and more preferably greater than or equal to 20 GPa. Wood having an elastic modulus of greater than or equal to 17 GPa is generally considered as a high elastic modulus material to be used for guitars, and thus is not usually used. It is more preferable for the rosewood that can be used for the wooden portion 30 to be wood having an elastic modulus that is higher than that of Indian rosewood. In this case, comparison is made using the average values of the elastic modulus, ascertained as a physical property of wood. For example, in general, Honduran rosewood satisfies the conditions of "elastic modulus of greater than or equal to 20 GPa" and "having an elastic modulus that is higher than that of Indian rosewood."

In addition, the rosewood to be used for the wooden portion 30 can be waste wood that was not used when manufacturing another musical instrument, or the like. For example, species of rosewood having particularly high rigidity are commonly used for marimbas. An example of rosewood having high rigidity is Honduran rosewood. Repurposing portions that could not be used during the manufacture of tone bars of a marimba contributes not only to cost reduction but also to improving sustainability.

In addition, from the viewpoint of improving appearance, the direction in which at least one side of the pickguard 21 extends is aligned with the grain direction, as viewed from the Z direction. As shown in FIG. 2, as viewed from the Z direction, the straight line L2 parallel to the one side 21a of the pickguard 21 is parallel to the straight line L1 indicating the grain direction; therefore, the one side 21a and the grain direction are aligned as viewed from the Z direction, resulting in a good appearance. Depending on the shape of the pickguard 21, one side of the pickguard 21 to be parallel to the grain direction is not limited to the one side 21a, and can be another side.

According to the present embodiment, since the grain direction of the wooden portion 30 is inclined relative to the longitudinal direction of the neck 3 of the guitar as viewed from the thickness direction of the body 20, the desired tonal quality can be obtained even when using rosewood for the body 20.

It is sufficient if the grain direction of at least a portion of the wooden portion 30 used in the body 20 satisfies the condition of being inclined relative to the longitudinal direction of the neck 3.

It is not essential that the direction in which at least one side of the pickguard 21 extends coincides with the grain direction. In addition, it is not essential to provide the pickguard 21.

It is sufficient if the center line A1 and the grain direction form the acute angle θ as viewed from the Z direction. Accordingly, the inclination of the grain direction can be reversed in the Y direction from that illustrated as an example. For example, in the present embodiment, the acute angle θ is an acute angle formed on the +Y side and on the +X side, but the acute angle θ can be an acute angle formed on the +Y side and on the -X side.

### Second Embodiment

The second embodiment of this disclosure differs from the first embodiment mainly in that the setting of the grain direction is different, but the other configurations are the same.

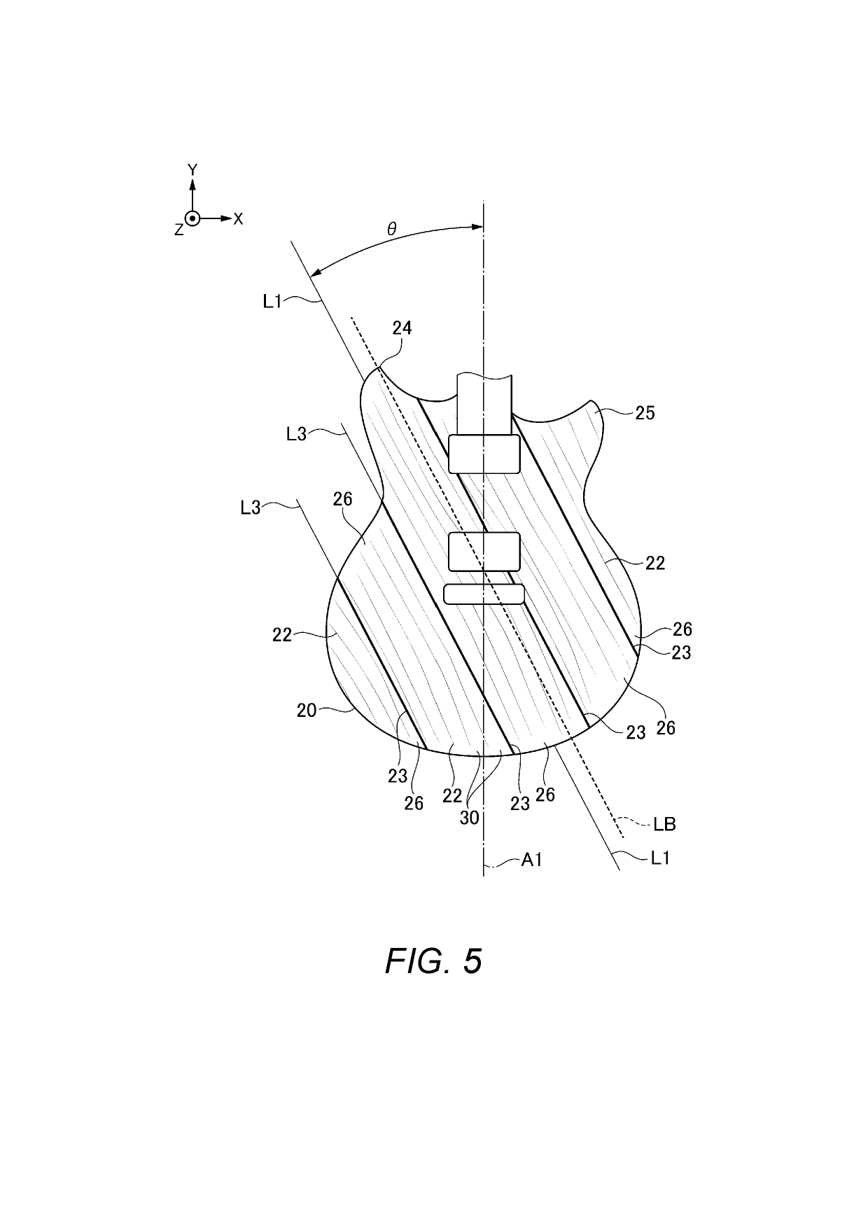

FIG. 5 is a front view of the body 20 in the present embodiment as viewed from the +Z side. The body 20 has two protrusions (first protrusion 24, second protrusion 25). The shape of the first protrusion 24 is different from the shape of the second protrusion 25, and the protrusion amount to the +Y side is greater for the first protrusion 24 than the second protrusion 25. Accordingly, the body 20 is formed in a shape that is asymmetric with respect to the center line A1. A straight line LB is an imaginary straight line obtained by extending a line segment that makes the length of the body 20 (distance between two points along the peripheral end) the longest, as viewed from the Z direction.

In the present embodiment, the grain direction is parallel to the straight line LB as viewed from the Z direction, that is, the grain direction extends in a direction in which the length of the body 20 becomes the longest as viewed from the Z direction. That is, the straight line L1 indicating the grain direction is parallel to the straight line LB. The acute angle θ formed by the center line A1 and the grain direction on the neck 3 side (and the side opposite to the neck 3) in the longitudinal direction of the neck 3 is slightly larger than 30˚.

If an inclination is not provided in the grain direction (acute angle θ = 0˚), the vibrational displacement at the first protrusion 24 having a large protruding length becomes greater than the vibrational displacement at the second protrusion 25. However, as a result of the straight line L1 being parallel to the straight line LB, vibration at the first protrusion 24 is suppressed compared to the second protrusion 25. Accordingly, it is possible to prevent excessive vibration occurring only in a portion of the body 20, and to allow the entire body 20 to vibrate in a well-balanced manner.

In addition, in the present embodiment, the wooden portion 30 is formed by joining a plurality of wooden pieces 26. An imaginary straight line parallel to the direction in which joining surfaces 23 of adjacent wooden pieces 26 extend as viewed from the Z direction is defined as a straight line L3. The straight line L3 and the grain direction coincide as viewed from the Z direction. As a result of the coincidence, the grain direction and the longitudinal direction of the wooden pieces 26 are aligned, resulting in a good appearance.

According to the present embodiment, as a result of tilting the grain direction, the same effect as that of the first embodiment can be achieved, in terms of obtaining the desired tonal quality even when using rosewood for the body 20.

In addition, in the body 20 having an asymmetric shape with respect to the center line A1, the grain direction extends in the direction in which the length of the body 20 becomes longest as viewed from the thickness direction, so that the peak frequency decreases, and the entire body is vibrated in a well-balanced manner, making it possible to obtain the desired tonal quality.

In addition, since the orientation of the joining surfaces 23 and the grain direction coincide as viewed from the Z direction, the grain direction and the longitudinal direction of the wooden pieces 26 are aligned, thereby improving the appearance.

It is not necessary to have both a configuration in which the grain direction (straight line L1) and the straight line LB are parallel to each other and a configuration in which the grain direction (straight line L1) and the straight line L3 are parallel to each other; being provided with only one of the foregoing configurations is also acceptable.

For example, in a configuration in which the wooden portion 30 has the joining surface 23, the grain direction and the straight line L3 can be parallel to each other while the grain direction and the straight line LB are not parallel to each other. Alternatively, the grain direction and the straight line LB can be parallel to each other while the grain direction and the straight line L3 are not parallel to each other. In addition, in a case in which the wooden portion 30 does not have the joining surface 23, the grain direction and the straight line LB can be parallel to each other.

Any of the foregoing configurations regarding the grain direction can be applied to a case in which the pickguard 21 is provided. In this case as well, a configuration can be adopted in which the direction in which at least one side of the pickguard 21 extends coincides with the grain direction, in the same manner as in the first embodiment. Moreover, the orientation of joining surfaces 23 of the plurality of wooden pieces 26 can coincide with the direction in which at least one side of the pickguard 21 extends as viewed from the thickness direction (the Z direction).

In the first embodiment, a configuration in which the wooden portion 30 has the joining surface 23 can be adopted. In this case, in the first embodiment, the grain direction and the orientation of the joining surface 23 can coincide.

### Third Embodiment

The third embodiment of this disclosure differs from the first embodiment mainly in that the configuration of the wooden portion and the setting of the grain direction are different, but the other configurations are the same.

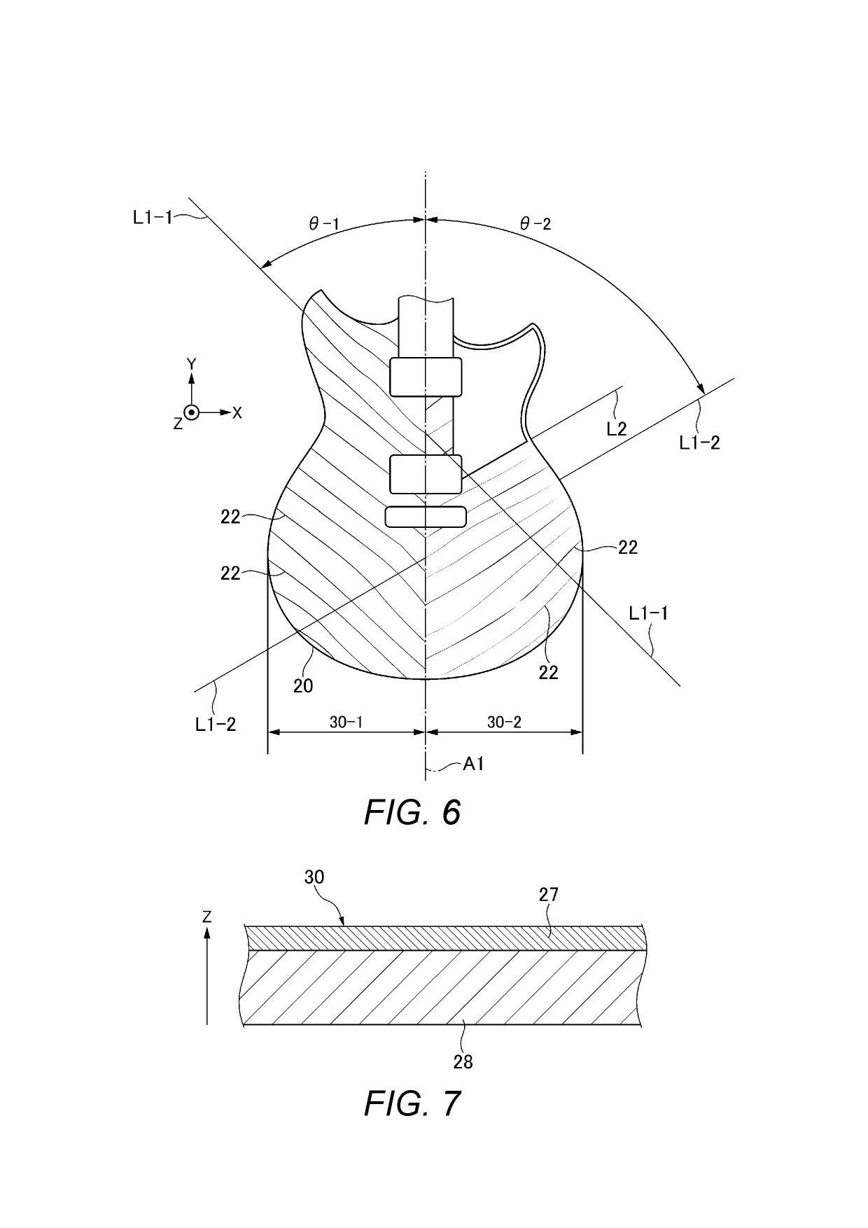

FIG. 6 is a front view of the body 20 in the present embodiment as viewed from the +Z side. In the present embodiment, the wooden portion included in the body 20 includes a first wooden portion 30-1 and a second wooden portion 30-2. As an example, the first wooden portion 30-1 and the second wooden portion 30-2 respectively belong to areas on the -X side and the +X side of the center line A1.

The grain direction of the first wooden portion 30-1 is parallel to a straight line L1-1. The grain direction of the second wooden portion 30-2 is parallel to a straight line L1-2. As viewed from the Z direction, the grain direction of the first wooden portion 30-1 (straight line L1-1) and the grain direction of the second wooden portion 30-2 (straight line L1-2) are line-symmetric with respect to the center line A1.

The center line A1 and the straight line L1-1 form an acute angle θ-1 on the neck 3 side (and the side opposite to the neck 3) in the longitudinal direction of the neck 3. The center line A1 and the straight line L1-2 form an acute angle θ-2 on the neck 3 side (and the side opposite to the neck 3) in the longitudinal direction of the neck 3. The size of the acute angle θ-1 and the size of the acute angle θ-2 are the same. The significance of the acute angles θ-1 and θ-2 is the same as that of the acute angle θ in the first embodiment, and the size thereof is 60˚, for example. The straight line L2 and the straight line L1-2 are parallel to each other.

Even when the grain direction is set in such a manner, the effect of reducing the rigidity of the body 20 in the longitudinal direction of the neck 3 is the same as that of the first embodiment.

According to the present embodiment, as a result of tilting the grain direction, the same effect as that of the first embodiment can be achieved in terms of obtaining the desired tonal quality even when using rosewood for the body 20.

In the present embodiment, the respective inclination directions of the wood grains 22 of the first wooden portion 30-1 and the second wooden portion 30-2 can be reversed in the Y direction from those shown in FIG. 6. That is, in the example shown in FIG. 6, the grain shape is V shaped as viewed from the Z direction with the +Y direction facing up, but the grain shape can be an inverted V shape. In this case, as viewed from the Z direction, the acute angle formed by the grain direction and the longitudinal direction of the neck 3 on the side opposite to the neck 3 (-Y side) in the longitudinal direction of the neck 3 can be greater than 0˚, can be greater than or equal to 30˚ and less than or equal to 70˚, but can be preferably 60˚.

In the present embodiment, the first wooden portion 30-1 and/or the second wooden portion 30-2 can be formed by joining a plurality of wooden pieces 26, as shown in the second embodiment. In this case, the grain direction of the first wooden portion 30-1 can coincide with the direction in which the joining surface 23 of the first wooden portion 30-1 extends. The grain direction of the second wooden portion 30-2 can coincide with the direction in which the joining surface 23 of the second wooden portion 30-2 extends.

It is not essential that the direction in which at least one side of the pickguard 21 extends coincides with the grain direction. In addition, it is not essential to provide the pickguard 21.

In each of the embodiments described above, the wooden portion 30 (or the first wooden portion 30-1 and the second wooden portion 30-2) can be formed by laminating a plurality of wooden layers, as illustrated in FIG. 7. A first modified example will be described using the wooden portion 30 as an example.

FIG. 7 is a schematic cross-sectional view of the wooden portion 30 of the first modified example. The wooden portion 30 is formed by laminating a first wooden layer 27 and a second wooden layer 28. The first wooden layer 27 and the second wooden layer 28 can have the same thickness, but have different thicknesses in the example shown in FIG. 7. While not shown, as viewed from the Z direction, the grain direction of the first wooden layer 27 and/or the second wooden layer 28 is inclined with respect to the longitudinal direction of the neck 3. The grain direction of the second wooden layer 28 is different from the grain direction of the first wooden layer 27. For example, the grain direction of the first wooden layer 27 can be parallel to the straight line L1-1 as shown in FIG. 6, and the grain direction of the second wooden layer 28 can be parallel to the straight line L1-2 as shown in FIG. 6.

In this manner, since the desired rigidity can be easily obtained by laminating wooden layers having different thicknesses and varying the grain directions of the two wooden layers, it becomes easy to finely adjust the peak frequency.

Either of the top side (+Z side) wooden layer or the back side (-Z side) wooden layer can be made thicker. The number of laminated wooden layers can be three or more. In addition, the grain direction of at least one of the plurality of laminated wooden layers can be inclined relative to the longitudinal direction of the neck 3. In addition, the grain direction of at least one of the plurality of laminated wooden layers can be different from the grain direction of at least one of the other layers.

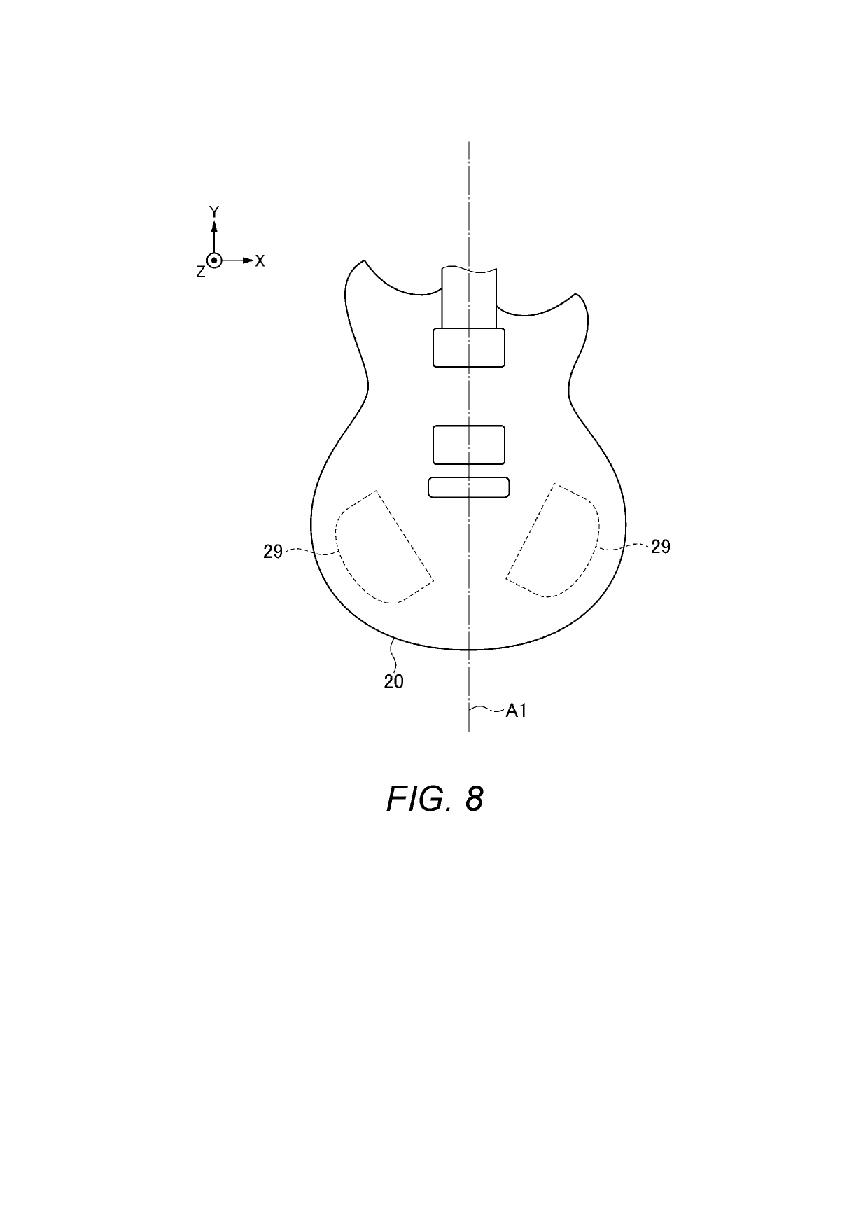

In each of the embodiments described above, the body 20 can be a solid body lacking a chamber (cavity) for weight reduction therein, or, as illustrated in FIG. 8, be a semi-solid body in which a chamber is formed. The second modified example will be described.

FIG. 8 is a front view of the body 20 of the second modified example as viewed from the +Z side. In FIG. 8, an illustration of the wood grains 22 is omitted. The body 20 is provided with one or more chambers 29. Providing the chambers 29 has the effect of reducing the rigidity of the body 20. Accordingly, when using rosewood having a high elastic modulus, the effect of reducing rigidity can be expected by the chambers 29 in addition to the inclination of the wood grains 22, making it easier to obtain the desired tonal quality.

This disclosure is suitable not only for electric guitars but also for electric basses, and an application thereof to acoustic guitars is also not excluded.

Compared to a case in which another wood with a lower elastic modulus than rosewood is used, the plate thickness of the body 20 may be made thinner when using rosewood.

This disclosure was described above based on preferred embodiments, but this disclosure is not limited to the above-described embodiments, and includes various embodiments that do not depart from the scope of the invention. Some of the above-described embodiments may be appropriately combined.

### Effects of this Disclosure

According to one embodiment of this disclosure, it is possible to obtain the desired tonal quality even when using rosewood for the body.

What is claimed is:

1. A body structure of a guitar comprising:
a body including a wooden portion made of rosewood,
as viewed from a thickness direction of the body, a grain direction of the wooden portion being inclined relative to a longitudinal direction of a neck of the guitar.

2. The body structure of the guitar according to claim 1, wherein
the rosewood is one of Indian rosewood, Madagascar rosewood, Honduran rosewood, jacaranda, sonokeling, or Guatemalan rosewood, or a combination of two or more of Indian rosewood, Madagascar rosewood, Honduran rosewood, jacaranda, sonokeling, or Guatemalan rosewood.

3. The body structure of the guitar according to claim 1, wherein
an acute angle formed by the longitudinal direction and the grain direction is 30˚ or more and 70˚ or less as viewed from the thickness direction.

4. The body structure of the guitar according to claim 1, wherein
the rosewood is wood having an elastic modulus of17 GPa or more.

5. The body structure of the guitar according to claim 1, wherein
the rosewood is wood having a higher elastic modulus than an elastic modulus of Indian rosewood.

6. The body structure of the guitar according to claim 1, wherein
the body has a shape that is asymmetric with respect to an imaginary straight line that passes through a center of the body in a width direction and extends in the longitudinal direction, and
the grain direction extends in a direction in which a length of the body becomes longest as viewed from the thickness direction.

7. The body structure of the guitar according to claim 1, wherein
the wooden portion includes a first wooden layer and a second wooden layer that is laminated on the first wooden layer, the first wooden layer and the second wooden layer have different thicknesses, and
a grain direction of the first wooden layer is inclined relative to the longitudinal direction as viewed from the thickness direction, and a grain direction of the second wooden layer is different from the grain direction of the first wooden layer.

8. The body structure of the guitar according to claim 1, wherein
the wooden portion includes a plurality of wooden pieces that are jointed, and
an orientation of joining surfaces of the plurality of wooden pieces coincides with the grain direction as viewed from the thickness direction.

9. The body structure of the guitar according to claim 1, wherein
the body has a pickguard, and
a direction in which at least one side of the pickguard extends coincides with the grain direction as viewed from the thickness direction.

10. The body structure of the guitar according to claim 9, wherein
the wooden portion includes a plurality of wooden pieces that are jointed, and
an orientation of joining surfaces of the plurality of wooden pieces coincides with a direction in which the at least one side of the pickguard extends as viewed from the thickness direction.

11. The body structure of the guitar according to claim 1, wherein
the wooden portion includes a first wooden portion and a second wooden portion, and
a grain direction of the first wooden portion and a grain direction of the second wooden portion are line-symmetric with respect to an imaginary straight line that passes through a center of the body in a width direction and extends in the longitudinal direction as viewed from the thickness direction.

12. The body structure of the guitar according to claim 1, wherein
the grain direction of the wooden portion is an orientation of fibers of the wooden portion.

13. The body structure of the guitar according to claim 1, wherein
the guitar is an electric guitar.

14. A guitar comprising:
the body structure of the guitar according to claim 1.
